(19) United States
(12) Patent Application Publication
(10) Pub. No.: US 2002/0024541 A1
(43) Pub. Date: Feb. 28, 2002

(54) IMAGE FORMING APPARATUS

(76) Inventors: SHOJI IMAIZUMI, SHINSHIRO-SHI (JP); KEIJI NAKATANI, TOYOKAWA-SHI (JP)

Correspondence Address: BURNS DOANE SWECKER & MATHIS L L P, POST OFFICE BOX 1404, ALEXANDRIA, VA, 22313-1404, US

(21) Appl. No.: 08/877,643

(22) Filed: Jun. 17, 1997

(30) Foreign Application Priority Data
Jun. 17, 1996 (JP) 8-155359
Jun. 17, 1996 (JP) 8-155361

(51) Int. Cl. H04N 1/034

(52) U.S. Cl. 347/3; 347/104

(57) ABSTRACT

An image forming apparatus has an electrophotographic part for printing a monochromatic image and an ink jet part for printing a color image. A switch device selects to carry a sheet of paper which has been printed by the electrophotographic part directly to the external tray or to carry the sheet of paper through an intermediate tray to the ink jet part for printing a color image. Once the switch device selects to carry the sheet of paper to the ink jet part, the switch device is inhibited to discharge directly a sheet of paper on which an image is formed by the electrophotographic part. Thus, the order of the printed papers is kept the same as that of the original documents.

### BACKGROUND OF THE INVENTION

1. Field of the Invention

This invention relates to an image forming apparatus such as a printer or a copying machine.

2. Description of Prior Art

An image forming apparatus is proposed which combines an image forming part using electrophotographic process (hereinafter referred to as electrophotographic part) and another image forming part using ink jet printing process (hereafter referred to as ink jet part). In the proper image forming apparatus, a monochromatic document is printed in the electrophotographic part and a color document is printed in the ink jet part. After the electrophotographic part forms an image on a sheet of paper, the sheet is carried through the ink jet part. This image forming apparatus prints a color document with the ink jet part of low cost and copies a monochromatic document at a high speed in the electrophotographic part.

In the image forming apparatus, printing of a monochromatic document in the electrophotographic part will complete in a shorter time than printing of a color document in the ink jet part. The electrophotographic part is located at the upstream side along the paper supply direction than the ink jet part. Therefore, when a document group including monochromatic documents and color documents is printed continuously by the image forming apparatus, if a mono- chromatic document is printed after a color document, printing of the monochromatic document has to be waited while the color document is being printed by the ink jet part. Therefore, even if a monochromatic image is printed at high speed, the productivity of copying operation decreases largely when color documents exist in a document group.

This problem may be solved by providing another paper supply path which guides papers directly from the electrophotographic part to a tray. However, this causes another problem that the order of the papers compiled on the tray is different from that in the original order in the document group.

As mentioned above, printing of a monochromatic document in the electrophotographic part will complete in a shorter time than printing of a color document in the ink jet part. Then, it is necessary to stop a sheet of paper on which a monochromatic image has already been printed just before the ink jet part or to wait a next sheet of paper to be supplied to the electrophotographic part. In such a case, a monochromatic image is fixed at random times in the electrophotographic part, and electric power is used wastefully for temperature control for the fixing process. Further, because color printing is performed after a sheet of paper passes the electrophotographic part, the paper may be subjected to bad effects by the electrophotographic part. For example, the sheet of paper may be bent or residual toners remain on the paper when the paper arrives to the ink jet part.

### SUMMARY OF THE INVENTION

An object of this invention is to provide an image forming apparatus which forms images of a document group including monochromatic documents and color documents at a fast speed without changing the order of the documents.

In one aspect of the invention, an image forming apparatus comprises a first image forming part (for example, an electrophotography part) and a second image forming part (for example, an ink jet part) for forming an image on a sheet of paper. Three paths connecting them are provided. A first path carries a sheet of paper through the first image forming part, a second path carries a sheet of paper through the second image forming part, and a third path carries a sheet of paper to an external tray. A switch device connects the first path to the second path or to the third path. When images of a plurality of documents are formed successively, a controller inhibits the switch device to connect the first path to the third path if the switch device once connects the first path to the second path. Then, when the first and second image forming parts forms images sequentially on a sheet of paper, even if the second image forming part forms an image slower than the first one, the order of prints is kept the same as that in the original documents.

Preferably, further comprising an image discrimination means for discriminating a color area included in a document, wherein an image of the color area is formed by the second image forming part when the image discrimination means discriminates the color area. Preferably, if no color area is included in a next document, the second image forming part only passes a sheet of paper carried through the second path, without forming an image on the sheet of paper.

In a second aspect of the invention, an image forming apparatus comprises a first image forming part (for example, an electrophotography part) and a second image forming part (for example, an ink jet part) for forming an image on a sheet of paper, and an intermediate tray is provided between the two image forming parts for stacking a paper discharged from the first image forming part. The intermediate tray can absorb time lag when processing speed of the two image forming parts are different from each other, and the second image forming part performs image forming irrespective of the image forming in the first image forming part.

An advantage of the present invention is that image forming can be performed faster by keeping the order of the printed papers the same as that of the original documents.

Another advantage of the present invention is that the second image forming part can form an image without considering image forming in the first image forming part if the image forming speed of the second image forming device is slower than that of the first one.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a sectional view of a copying machine of an embodiment of this invention;

FIG. 2 is an elevational view of an operational panel of the copying machine;

FIG. 3 is a block diagram of image forming including an image processing circuit;

FIG. 4 is a perspective view of an ink jet unit;

FIG. 5 is a perspective view of a part of the ink jet unit;

FIG. 6 is perspective view of an intermediate tray;

FIG. 7 is an image diagram for illustrating the order of data storage of color areas in a document image;

FIG. 8 is an image diagram for illustrating data storage in a hard disk;

FIGS. 9A, 9B and 9C are diagrams for illustrating a flow of the generalized block truncation coding;

FIGS. 10A, 10B and 10C are diagrams on encoding and decoding in the generalized block truncation coding;

FIG. 11 is a main flowchart of a central processing unit in the image forming apparatus;

FIG. 12 is a flowchart of mode setting;

FIGS. 13A and 13B are flowcharts of image forming;

FIG. 14 is a flowchart of document discrimination; and

FIG. 15 is a flowchart of ink jet image forming.

### DETAILED DESCRIPTION OF THE PREFERRED EMBODIMENTS

Referring now to the drawings wherein like reference characters designate like or corresponding parts throughout the views, an embodiment of the invention is explained below.

(1) Structure of Copying Machine

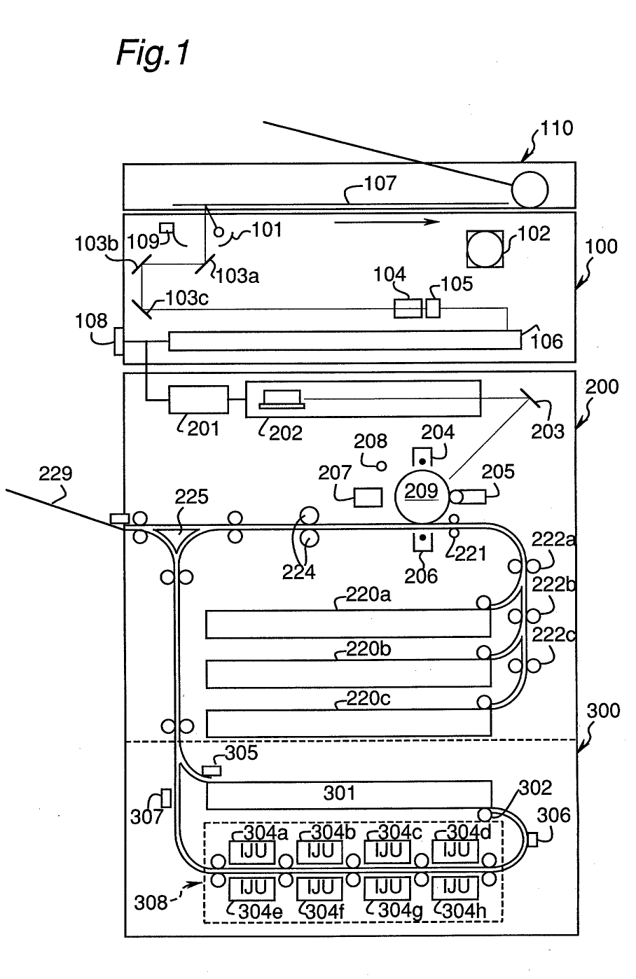

FIG. 1 is a sectional view of the copying machine of an embodiment of this invention. This copying machine is composed of an image reader 100 having an automatic document feeder 110, an electrophotographic part (image forming part using electrophotographic process) 200, and an ink jet part (image forming part using ink jet printing process) 300.

First, a document image is read in the image reader 100. The automatic document feeder 110 is mounted at the upper part of the image reader 100. A document in the automatic document feeder 110 is set automatically at a fixed position on a platen glass 107 and is illuminated with an exposure lamp 101. A document in the documents in the automatic document feeder 110 is set on the platen glass 107 sequentially. A light reflected from a document face is guided through mirrors 103a, 103b and 103c and a lens 104 and is focused onto a charge coupled device (CCD) sensor 104. The exposure lamp 101 and the mirror 103a are moved by a scanner motor 102 in the subscan direction (the direction represented with an arrow) at a speed V corresponding to the copy magnification and scan the entire document. The mirrors 103b and 103c are moved in the same direction at a speed of V/2 according to the movement of exposure lamp 101 and mirror 103a. The CCD sensor 105 converts the incident light to analog, electrical signals. The electrical signals are converted into 8-bit gradation data of Y (yellow), M (magenta), C (cyan), and K (black), and after shading correction and the like in the image processing circuit 106, the electric signals are supplied to an interface 108 and the electrophotographic part 200 or the ink jet part 300.

An image is formed in the electrophotographic part 200 as follows: After mutual transfer function correction, gamma correction and the like for the 8-bit gradation data, an image data corrector 201 sends data to an exposure head 202 to emit a laser beam. The laser beam exposes a photoconductor drum 209 through a mirror 203. The photoconductor drum 209 is uniformly charged for a fixed voltage with a sensitizing charger 204 before the exposure for every copying operation. When the photoconductor drum 209 is exposed under such a condition, an electrostatic latent image of the document is formed thereon, and it is developed with a toner development unit 205 of black. On the other hand, a sheet of paper is supplied from one of paper cassettes 220a-220c in correspondence to the document size through carriage rollers 222a-222c and a timing roller 221 to a transfer section. Thus, at the transfer section, the developed toner image is transferred on the paper with a transfer charger 206, and it is fixed with a fixing roller 224. A fur brush 207 collects toners remained on the photoconductor drum 209 after the transfer. A main eraser 208 removes residual electric charges on the surface of the photoconductor drum 209. A claw 225 supplies the sheet of paper on which the electrophotographic part forms an image to a path to a tray 229 or a path to the ink jet part 300 installed below the electrophotographic part 200.

A color image is formed in the ink jet part 300 as explained below. A sheet of paper supplied from any of the paper cassettes and have passed the electrophotographic part 200 is guided by the claw 225 and is stacked in an intermediate tray 301 formed between the electrophotographic part 200 and the ink jet part 300. A sensor 305 detects a sheet of paper carried to the intermediate tray 301. A refeeding roller 302 carries a sheet of paper in the intermediate tray 301 from the lowest one stacked therein to an ink jet section 308. Another sensor 306 detects a sheet of paper carried from the intermediate tray 301. The structure of the intermediate tray 300 and the image forming in the ink jet part 300 are explained later.

The ink jet section 308 has four ink jet units (IJU) 304a-304d above the paper supply path and four ink jet units 304e -304h below it along the paper supply path in series at each equal intervals (105 mm, or ¼ of the maximum size 420 mm) between them. The ink jet units 304a-304h are detachable from the main body of the copying machine, and the number and the positions thereof can be selected in response to user's environment. For example, a color image can print on both faces by mounting at least two ink jet units 304a and 304e at the same time. Moreover, when the ink jet units 304a-304d are mounted, the area printed by one unit becomes ¼ of the counterpart when only the ink jet unit 304a is mounted, and print speed can be increased four times. The sheet of paper outgoing from the ink jet section 308 is discharged to the tray 229 by passing a longitudinal path. The sensor 307 detects the end of the printing in the ink jet section 308 by detecting the paper. The structure of the ink jet units 304a-304h is explained later.

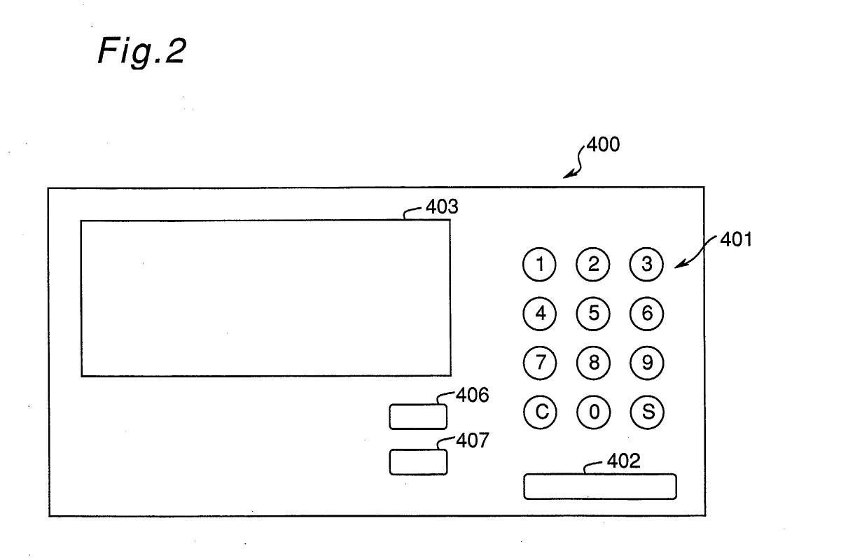

FIG. 2 shows an operational panel 400 of the digital copying machine. The operational panel 400 comprises ten-keys 401, a key 402 for starting copy operation, a liquid crystal display device 403 for setting a mode and displaying copy statuses, a key 406 for selecting quality mode which forms an image only by using the ink jet part 300, and a key 407 for selecting high speed mode which forms an image only by using the electrophotographic part 200. When either of the quality mode and the high speed mode is not set, a complex mode is set for forming an image by using the ink jet part 300 and the electrophotographic part 200. The copy operations in each mode is explained later.

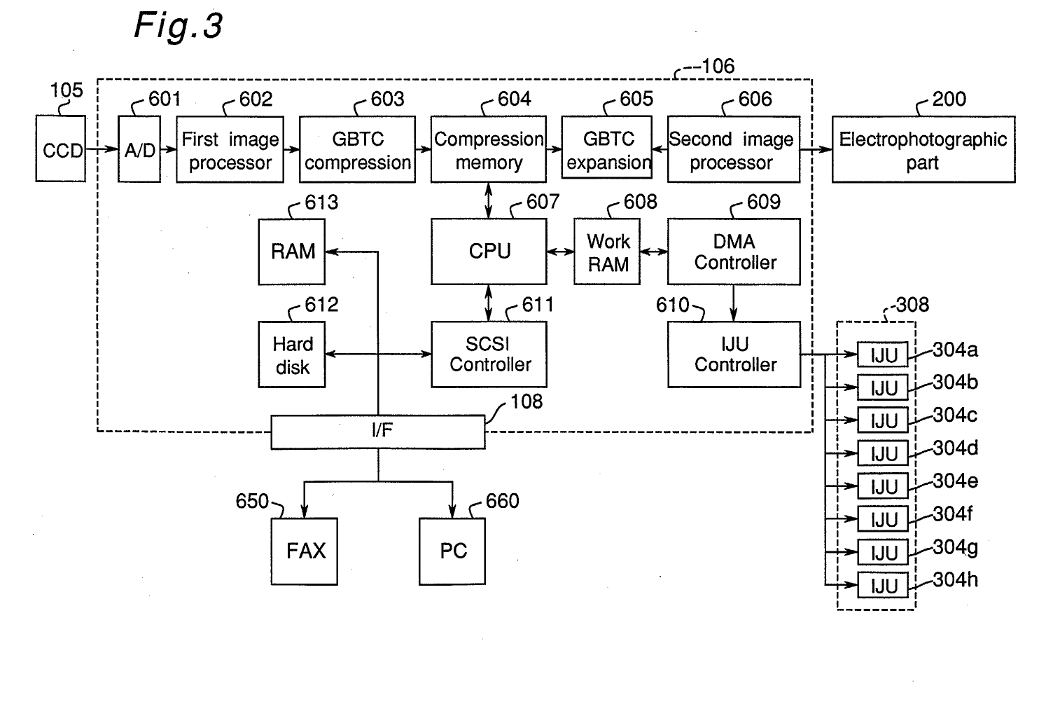

FIG. 3 shows image processing including the image processing circuit 106. The analog electric signal output from the CCD sensor 105 are converted by an A/D converter 601 to digital signals, and they are subjected to predetermined shading correction. The first image processor 602 converts the image data of three primary colors of red (R), green (G) and blue (B) to Y,Cr,Cb data on lightness and chromaticity. The Y,Cr,Cb data are suitable for coding because difference in colors and blur are not noticeable even if each data is changed by calculation errors. A generalized block truncation coding (GBTC) compression circuit 603 codes the data received from the first image processor 602 according to a coding process called as generalized block truncation coding (hereinafter referred to also as GBTC) to decrease the amount of data and stores the encoded data in a compression memory 604. The encoding processing is explained later.

A central processing unit (CPU) 607 distinguishes areas of monochromatic image to be processed in the electrophotographic part 200 and areas of color image to be processed in the ink jet part 300 based on the code data in the compression memory 604. The attribute map is prepared based on the discrimination result and the attribute map is stored in the hard disk 612. As to the areas of color image. the data in the compression memory 604 are replaced with data which represent white pixels, and the data of the color image are saved through a SCSI controller 611 in the hard disk 612 so as not to form an image with the electrophotographic part 200.

A generalized block truncation coding (GBTC) expansion circuit 605 expands the code data stored in the compression memory 604 at predetermined timings, and after the mutual transfer function correction, the gradation correction and the like on the expanded data, a second image processor 606 outputs the expanded data to the electrophotographic part 200. Moreover, the CPU 607 transfers the color image data stored in the hard disk 612 to the work random access memory (RAM) 608 by processing the data in a format for image forming if necessary. A direct memory access (DMA) controller 610 transfers the image data in the work RAM 608 to an ink jet unit controller 610. The ink jet unit controller 610 transfers appropriate image data to the ink jet units 304a-304h in the ink jet section 308 to instruct color image forming.

The image data read by the image reader 100 or the signals output from the CCD sensor 105 can be output to an external apparatus such as a facsimile apparatus (FAX) 650 or a personal computers (PC) 660 through the image processing circuit 106 and the interface 108. Moreover, image data can be received from an external apparatus, and the received image data can be printed in the ink jet part 300. When no ink jet units are set in the ink jet image forming section 308, the data input from the interface 108 is stored in the RAM 613.

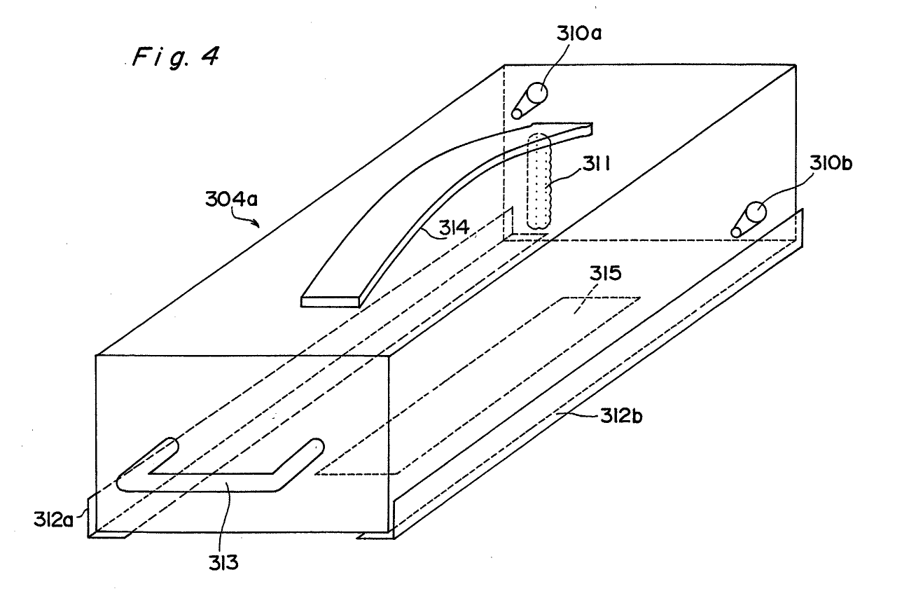

Next, the ink jet units 304a-304h are explained. The ink jet units 304a-304h have the same forms and structures. FIG. 4 shows the ink jet unit 304a. The ink jet unit 304a is put on slide rails 312a and 312b and is detachable from the main body of the copying machine by moving along the slide rails 312a and 312b. Handles 313 and 314 are provided for the ease of detaching. Because the ink jet unit 304a is fixed by inserting pins on the main body through holes 310a and 310b, and the signals are transmitted with the main body by connecting a connector 311 to the counterpart in the main body. An opening 315 for ink jet is provided at the bottom of the ink jet unit 304a, for recording an image on the paper.

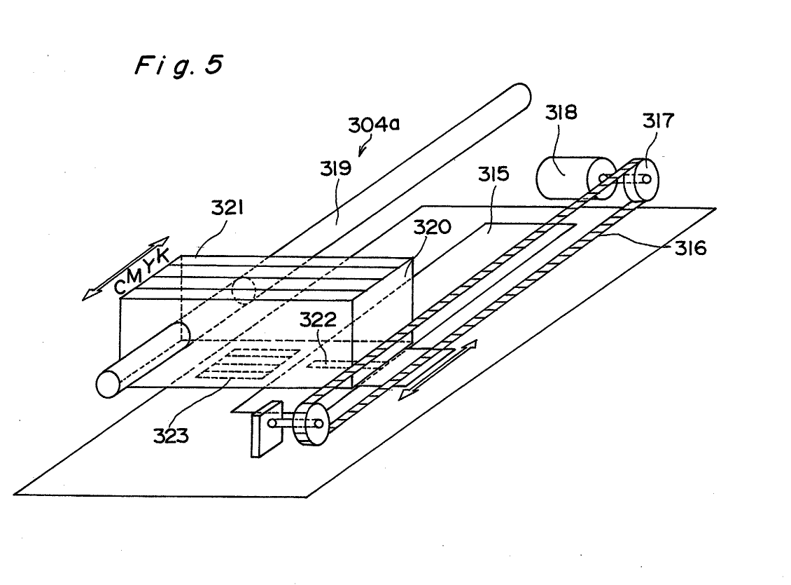

FIG. 5 shows an internal structure in the ink jet unit 304a. Ink jet heads 320 are supported with a shaft 319 at one side and is connected with a belt 316 at the other side. The belt 316 is moved by the rotation of a gear 317 connected to a driving motor 318, so that the ink jet heads 320 are carried in the directions shown with a double arrow shown in FIG. 5. Inks of a plurality of colors are contained in ink cartridges 321, and the inks are supplied to the ink jet heads 320 for each color. An ink jet through a slit 322 from the ink jet head 320 passes an opening 315 at the bottom to adhere to a paper. After the ink jet heads 320 are moved from one end to the other end along the shaft 319, the paper is moved by one step according to print width. An image is formed on the paper by repeating this process. The ink jet unit 304 further has a sensor 323 for detecting the existence of ink, a controller (not shown) of the motor 318 and a circuit (not shown) which transfers signals with the main body of the copying machine through the connector 311. The ink jet units 304e-304h for printing a back face have the same structure as shown in FIGS. 4 and 5, but they are installed upside down.

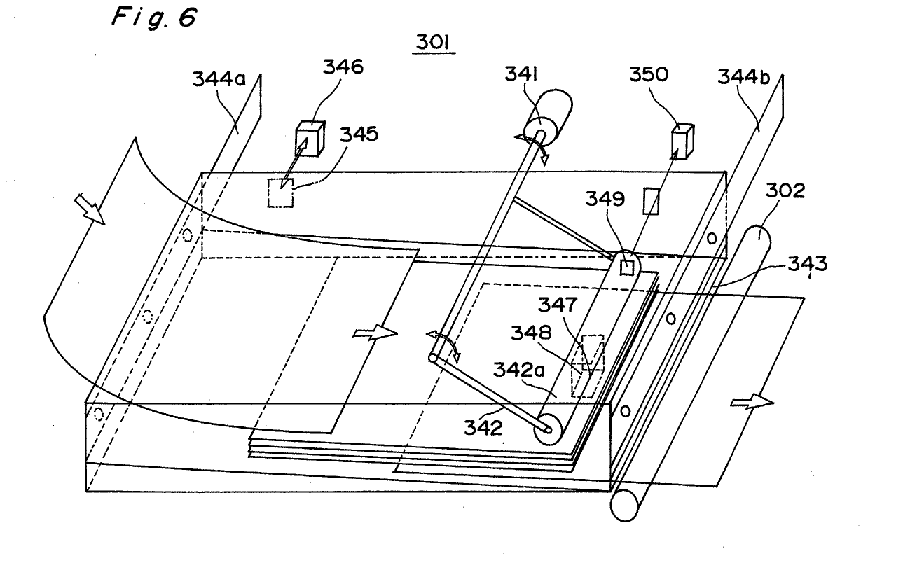

Next, FIG. 6 shows a structure of the intermediate tray 301. A lever 342 for suppressing a paper is connected with a rotation shaft of a motor 341. The lever 342 suppresses the papers in the intermediate tray 301 according to clockwise rotation of the motor 341. A roller 342a is provided at a portion where the lever 342 touches the paper in order to supply a paper smoothly. The bottom of the intermediate tray 301 is inclined so that an opening for refeeding the paper becomes low, and the papers are moved down to a roller 302 for refeeding.

A paper to which a monochromatic image is printed by the electrophotographic part 200 is carried from the upper left side in FIG. G into the intermediate tray 301. When the paper is stored, the motor 341 rotates counterclockwise and releases the suppression of the papers with the lever 342. On the other hand, when the ink jet section 308 can perform printing, the motor 341 rotates clockwise to suppress the papers with the lever 342. According to the rotation of the refeeding roller 302, the papers stored in the intermediate tray 301 are supplied successively from the lowest paper through the opening 343.

The intermediate tray 301 is mounted to the main body of the copying machine by slide rails 344a and 344b, and it is detachable from the main body of the copying machine. Therefore, if papers are set in the intermediate tray 301 beforehand, it is not needed to feed the papers through the electrophotographic part 200. Therefore, bad influences such as black toner scattering or the like in the electrophotographic part 200 can be avoided, and a paper supply time is shortened. Thus, color printing of high quality can be performed faster.

A sensor 346 for detecting the intermediate tray 301 consists of a light-emitting element and a light-receiving element. When the intermediate tray 301 is installed, a light emitted by the light-emitting element and reflected by a side of the intermediate tray 301 is received by the light- receiving element. Another light-emitting element 349 is provided at a side of the roller 342a for suppressing the papers, and a sensor 350 detects whether the number of sheets of the paper accommodated in intermediate tray 301 reaches the maximum or not by receiving a light emitted by the light-emitting element 349. Further, a different light-emitting element 347 is installed at the center of the roller 342a, and a sensor 348 installed at the bottom of intermediate tray 301 detects the presence of the papers in the intermediate tray 301 by detecting a light emitted by the light-emitting element 347.

(2) Image Data Processing

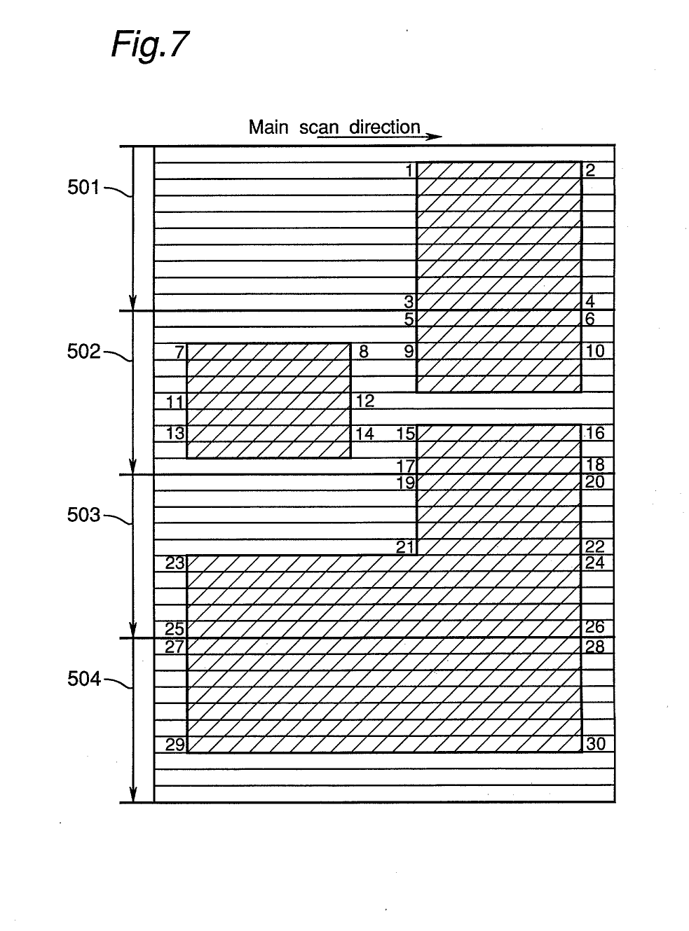

Image data for image forming are stored in the hard disk 612. FIG. 7 shows the data in a document image in the hard disk 612 including data of color areas. The order of data storage in the hard disk is explained when the data of the areas discriminated as color images is saved in the hard disk 612. The areas shown with the hatched lines represent areas of the color image. The GBTC encoding explained later is a fixed length encoding, and the data in the compression memory 604 is arranged similarly to this diagram.

The CPU 607 discriminates areas of monochromatic image and areas of color image based on the data in the compression memory 604, makes an attribute map based on this discrimination result, and stores it in the hard disk 612. The numbers shown in FIG. 7 represent the order of raster scan of the data along the main scan direction from the top left point. Four areas 501, 502, 503 and 504 mean areas to be printed by the ink jet units 304a, 304b, 304c and 304d installed at equal intervals. A horizontal line represents print width (sixteen pixels) of the ink jet heads.

The data belonging to color image areas are read in raster scan in order of the number according to the attribute map and stored in the hard disk 612. As shown in FIG. 7, a line data from 1 to 2 is scanned in the main scan direction from left to right and stored in the hard disk 612. Then, following line data are scanned and stored in the hard disk 612 similarly down to the line data between 3 and 4 sequentially in the first area 501. In the second area 502, a line data from 5 to 6 and a following line are scanned in the main scan direction from left to right similarly and stored in the hard disk 612. Next, a line data from 7 to 8 and a line data from 9 to 10 in the same line are scanned and stored in the hard disk 612. Data reading is continued similarly for each line down to the last line from 29 to 30.

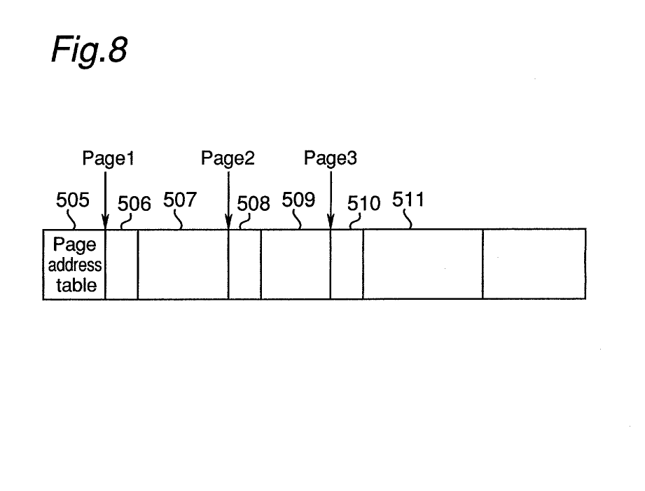

FIG. 8 is an image chart on the data stored in the hard disk 612. At the head in the hard disk 612, a page address table 505 is provided which shows the positions of the attribute maps for each page and sizes of the attribute map depending on the document size. After the page address table 505, an attribute map 506 and color image data 507 in the first page, an attribute map 508 and color image data 509 in the second page, and an attribute map 510 and color image data 511 in the third page are stored successively. The CPU 607 reads the attribute map on a desired page by referring to the page address table 505. If the document size is A3, the size of the attribute map is about 64 Kbytes. The color image data of each page is stored continuously after the corresponding attribute map. The data size thereof is different depending on the ratio of the color images in the document. If all image in an A3 document is a color image, the size of the color image data becomes about 35 MBytes.

The positions of the color images in the document image can be determined from the page address table 505 and the attribute map on the page specified with the page address table 505. Then, color image data can be supplied to the ink jet units 304a-304h. In the document shown in FIG. 7, when the data of the color image is read from hard disk 612, the data in the four areas 501-504 are allocated to the four ink jet units 304a-304d. For example, when the first line is printed by the units, the data is not supplied to the ink jet unit 304a. On the other hand, the data of the line of 5 to 6 is supplied to the ink jet unit 304b, and the data of the line of 19 to 20 is supplied to the ink jet unit 304c and the data of the line of 27 to 28 is supplied to the ink jet unit 304d.

Next, the principle of generalized block truncation coding (GBTC) is explained. Image data of a document are divided into blocks each consisting of 4*4 pixels. (The image data is processed by every four blocks in the subscan direction.) In each block, an average Q1 is calculated of data equal to or smaller than P1 determined by the data in the block, and another average Q4 is calculated of data equal to or larger than P1 determined by the data in the block where P1<P2. Then, an average information LA is defined as a half of a sum of the averages Q1 and Q4 and a gradation width index LD is defined as a difference between the averages Q1 and Q4. Then, the image data in the block are compressed by quantizing them at gradation levels the number of which is smaller than the number of the gradation levels. In the GBTC encoding, the data of 16*3 bytes are compressed to 6*3 bytes data as explained below.

In the copying machine, the average information LA and the gradation width index LD are used to discriminate whether the image in the block is a monochromatic image or a color image, and a document type is decided according to the discrimination result. However, the discrimination is not limited to this method, and for example, the document type may be decided from YCrCb data.

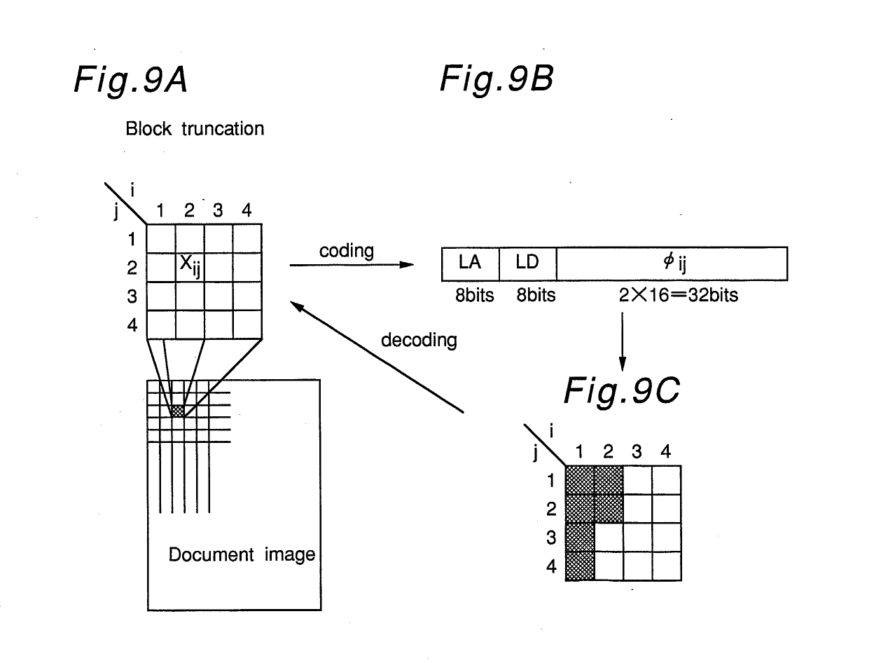

FIGS. 9A-9C show a coding flow in the generalized block truncation coding. As shown in FIG. 9A, a document image is divided into blocks, and the size of each block is 4*4 pixels Xij where i and j denote column and row. Then, image data for each block are coded as explained later according generalized block truncation coding by using parameters determined for each block. Then, as shown in FIG. 9B, the 8-bit image data (of 256 gradation levels) of 16 pixels (16 bytes) are compressed to 6-byte code data consisting of a 1-byte average data LA, a 1-byte gradation width index LD and 2-bit code data øij (four gradation levels) for 16 pixels. The data LA and LD are determined according to parameters determined from the image data in each block. Thus, as shown in FIG. 9B, an amount of data is reduced to 6 bytes, or the image data are compressed to ⅜ of the amount thereof. The coded data shown in FIG. 9B are decoded by using the parameter data LA and LD. In the embodiments explained below, the block size is 4*4 matrix. However, the invention is not limited to blocks of 4*4 pixels, and blocks of, for example, 3*3 pixels or 6*6 pixels may by used. Further, in the embodiments explained below, the number of gradation levels of the code data is four, but it may be two or eight.

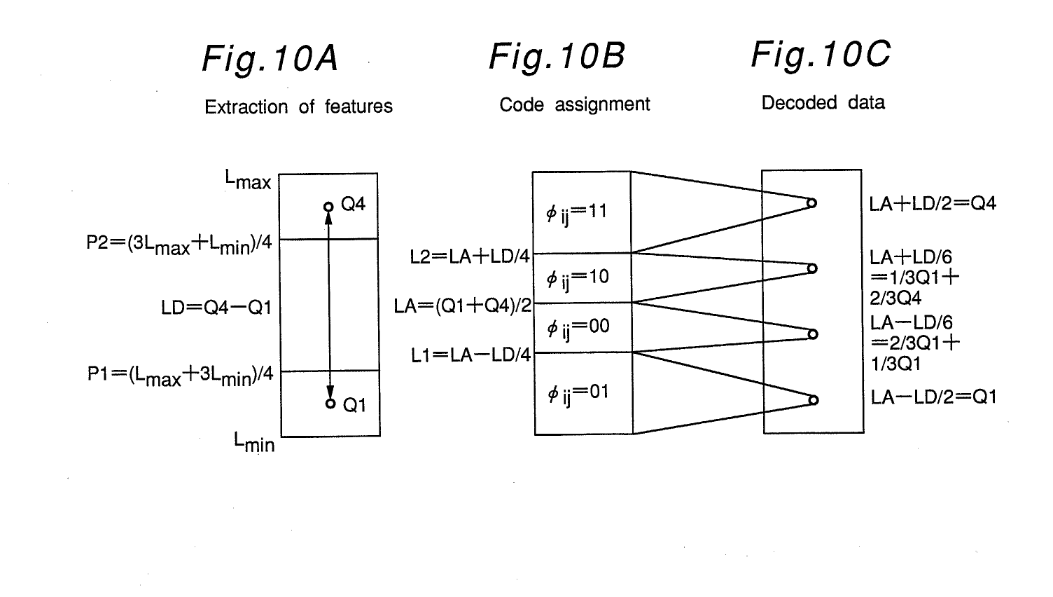

FIGS. 10A and 10B are diagrams for explaining coding and decoding of generalized block truncation coding. Each block of 4*4 pixels includes 16 8-bit image data, where a maximum Lₘₐₓ and a minimum Lₘᵢₙ represent a maximum and a minimum of the image data in the block. As shown in FIG. 10A, the image data are divided into three groups by using the parameters P1 and P2 larger than P1, both determined appropriately according to the image data in the block. The parameters P1 and P2 are determined as follows in this example:

P1=(Lₘₐₓ₊3 *L^{min})/4 (1)

and

P2=(3*Lₘₐₓ+Lₘᵢₙ)/4 (2)

Next, the first average Q1 is obtained on the image data of a group of the pixels having a pixel data lower than P1, while the second average Q4 is obtained on the image data of a group of the pixels having a pixel data larger than P2. Then, the average information LA and gradation width index LD are determined as follows:

LA=(Q1+Q4)/2, (3)

and

LD=Q4−Q1. (4)

Next, levels L1 and L2 for quantization are determined as follows:

L1=LA−LD/4, (5)

and

L2=LA+LD/4. (6)

Then, the image data in the block are quantized as 2-bit codes φᵢⱼ by using the three levels, L2, LA and L1. FIG. 10B shows code data φᵢⱼ for a pixel data Xᵢⱼ for i-th column and j-th row where i, j=1, 2, 3 or 4.

TABLE 1
Code data φᵢⱼ

| Range of 1-byte | 2-bit code data |
|---|---|
| data Xᵢⱼ | φᵢⱼ |
| Xᵢⱼ ≦ L1 | φᵢⱼ = 01 |
| L1 < Xᵢⱼ ≦ LA | φᵢⱼ = 00 |
| LA < Xᵢⱼ ≦ L2 | φᵢⱼ = 01 |
| L2 < Xᵢⱼ | φᵢⱼ = 11 |

Table 1 shows the code assignment in detail for 2-bit code φᵢⱼ for 1-byte data Xᵢⱼ. The data obtained by generalized block truncation coding comprises 2-bit code data φᵢⱼ of 16 pixels (4 bytes), a 1-byte gradation width index LD and a 1-byte average data LA (FIG. 9B).

TABLE 2
Conversion of data φᵢⱼ to Yᵢⱼ

| 2-bit code data φᵢⱼ | Gradation data |
|---|---|
| for image data Xᵢⱼ | after conversion |
| φᵢⱼ = 01 | Yᵢⱼ = LA − LD/2 |
| | = Q1 |
| φᵢⱼ = 00 | Yᵢⱼ = LA − LD/6 |
| | = 2/3Q1 + 1/3Q4 |
| φᵢⱼ = 10 | Yᵢⱼ = LA + LD/6 |
| | = 1/3Q1 + 2/3Q4 |
| φᵢⱼ = 11 | Yᵢⱼ = LA + LD/2 |
| | = Q4 |

As shown in FIG. 10B, the gradation width index LD and the average information LA are used to decode the code data. That is, a code data øᵢⱼ assigned for a data Xᵢⱼ is converted to 8-bit gradation data Yᵢⱼ as shown in Table 2. Then, the image data Xᵢⱼ of 256 gradation levels are converted to data Yᵢⱼ of four levels in the 256 levels. Therefore, the decoded data will include errors with respect to the original image data. However, the errors are not obvious according to human visual characteristics, and image deterioration is not observed for a half-tone image practically. In the decoded data, the parameters Q1 and Q4 are recovered from the average data LA and the gradation width index LD included in the coded data. Therefore, this can be completely reproduced from the encoded data in the character image having a black part of parameter P1 or smaller and a white part of parameter P2 or larger (monochromatic bi-level image).

(3) Image Forming Processing

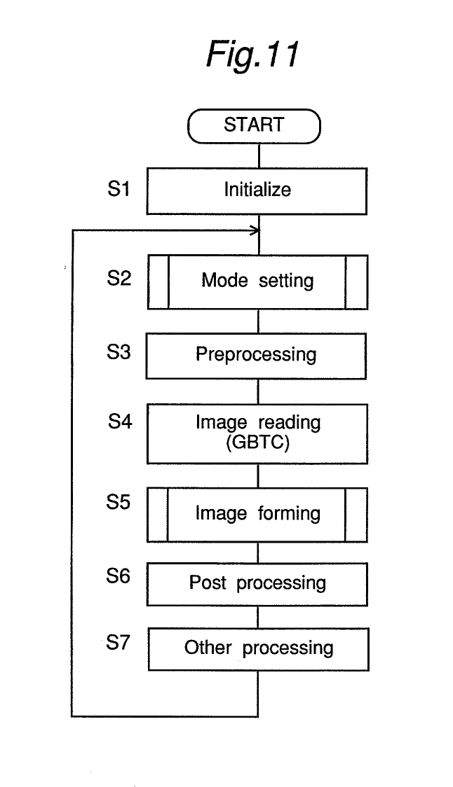

FIG. 11 is a main flowchart of the image forming processing executed by the CPU 607. The operation of the image forming is explained in detail according to this flow. First, variables used in the flow are initialized, and each element is initialized (step S1). Next, a key input by a user is received, and a various mode therefor is set (step S2). In this mode setting, when start key 402 is pressed by the user, the flow advances to the following processings. First, preprocessing such as shading correction and preparation for each element for image reading are performed according to the mode set by the user (step S3). Next, image data of a document put on the platen glass 107 by the automatic document feeder 110 is read, and after generalized block truncation coding thereon, the code data is stored in the compression memory 604 (step S4). The document discrimination is executed based on the data stored in the compression memory 604, and the image forming according to the document type is executed (step S5). This image forming is explained later. After the image forming, processings such as cleaning of the photoconductor 209 not related directly to the copy operation but necessary to maintain the conditions of the copying machine is performed (step S6). Finally, other processings such as communication control not related directly to the above-mentioned processing are executed (step S7). Then, the flow returns to step S2 to repeat the above-mentioned steps S2-S7.

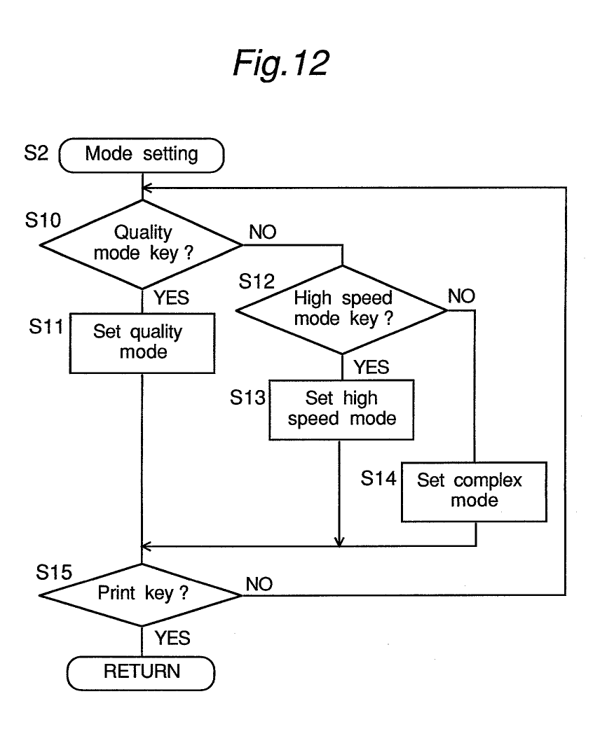

FIG. 12 is a flowchart of the mode setting (FIG. 11, step S2). When a user presses the quality mode key 406 (YES at step S10), quality mode is set as print mode (step S11). Quality mode uses only the ink jet part 300 irrespective of document type to produce a copy of high image quality. On the other hand, when a user presses the high speed mode key 407 (YES at step S12), high speed mode is set as print mode (step S13). High speed mode uses only the electrophotographic part 200 irrespective of document type to produce a copy and to discharge it to the tray 229. On the other hand, when either of the keys 406 and 407 is not pressed by the user (NO at step S12), a complex mode is set as print mode where both electrophotographic part 200 and ink jet part 300 are used according to the document type (step S14). Then, when print key 402 is pressed by the user (YES at step S15), the flow returns to the main routine.

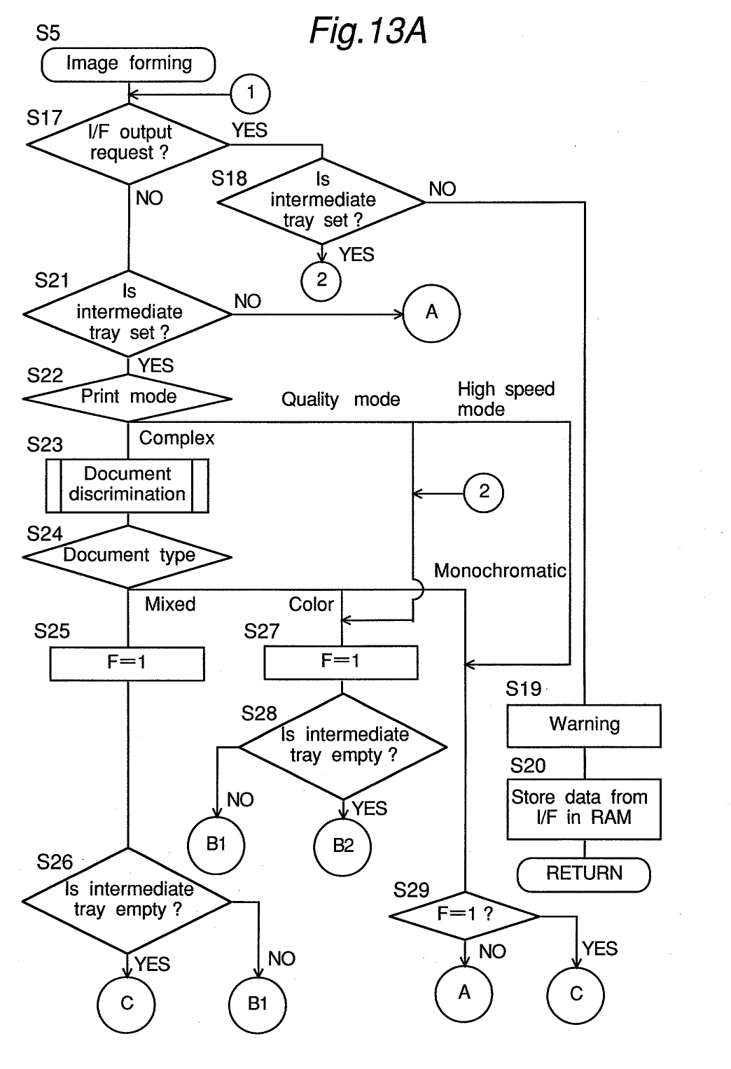

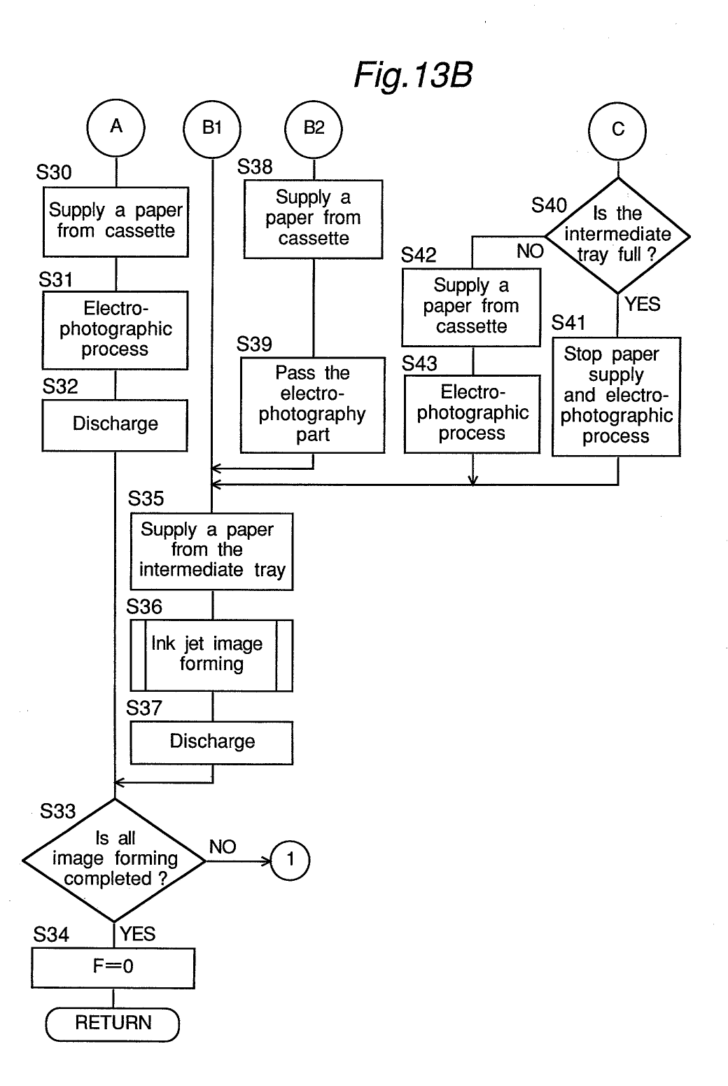

FIGS. 13A and 13B are flowcharts of the image forming (FIG. 11 and step S5). First, it is decided if an output request is received from the external apparatus through the interface 108 (step S17). If an output request is decided to be received (YES at step S17), because printing is allowed only for the ink jet part 300, it is decided whether the intermediate tray 301 is installed in the copying machine or not (step S18). If the intermediate tray 301 is decided to be installed in the copying machine (YES at step S18), the flow proceeds to step S27. Otherwise a warning message is displayed in the liquid crystal panel 403 in the operational panel 400 to demand the installation of the ink jet units (step S19), and data related to the output request are stored in the RAM 613 (step S20). Then, the flow returns.

If an output request is not decided to be received from the external (NO at step S17), and if the intermediate tray 301 is decided not to be set (NO at step S21), it is impossible to carry a sheet of paper through the intermediate tray 301 to the ink jet part 300. Then, printing in mode A is performed. That is, a sheet of paper is fed from one of the cassettes 220a-220c (step S30), a monochromatic image is formed by the electrophotographic part 200 (step S31), and the paper is discharged directly to the tray 229 without passing the ink jet part 300 (step S32).

On the other hand, if an output request is not decided to be received from the external (NO at step S17), and if the intermediate tray 301 is decided to be set (YES at step S21), the flow branches according to the print mode set by the user (step S22). In the complex mode, document type is discriminated (step S23), and the flow branches according to the document type (step S24). There are three document types: monochromatic document, color document and mixed document having color and monochromatic areas. If the document type is mixed document, mode flag F is set to 1 (step S25) in order for the paper to pass always the ink jet part 300 even for a monochromatic document. Then, if the intermediate tray 301 is decided to be empty (YES at step S26), printing in mode C is performed. That is, if the intermediate tray 301 is decided not to be full (NO at step S40), a paper is fed from one of the cassettes 220a-220c (step S42), and a monochromatic image is formed by the electrophotographic part 200 (step S43). Thus, the paper is once stored in the intermediate tray 301. Then, the flow proceeds to step S35. Next, a paper in the intermediate tray 301 is carried to the ink jet unit section 308 (step S35), and printing of cyan, magenta, yellow in the color areas is performed by the ink jet part 300 (step S36), and the paper is discharged to the tray 229 (step S37).

It is to be noted that print speed in the ink jet part 300 is slower than that of the electrophotographic part 200. Then, a plurality of sheets of paper may be stacked in the intermediate tray 301 in the order of image forming in the electrophotographic part 200. Then, if the intermediate tray 301 is decided to be full with the sensor 350 (YES at step S40), it is inhibited to supply a paper from one of the cassettes 220a-220c and to form an image by the electrophotographic part 200 (step S41), and the papers already stacked in the intermediate tray 301 waits to be processed in the ink jet part 300.

If a sheet of paper is already stacked in the intermediate tray 301 (NO at step S26), printing in mode B1 is performed. That is, a paper in the intermediate tray 301 is carried directly to the ink jet unit section 308 (step S35), without paper supply from the paper cassettes, and printing of cyan, magenta, yellow in the color areas is performed by the ink jet part 300 (step S36), and the paper is discharged to the tray 229 (step S37).

If the document type is decided to be a monochromatic image at step S23), the flow branches according to flag F (step S29). If the flag F is decided to be zero (NO at step S29), printing in the above-mentioned mode A is performed because it is decided that image forming by the ink jet part 300 is not performed. On the other hand, if the flag F is decided to be one (YES at step S29), color printing has already been performed by the ink jet part 300 for a part or the whole part in the document image, and printing in the above-mentioned mode C is performed.

However, image forming is not performed by the ink jet units 304a-304h for papers which are received from the intermediate tray 301 after monochromatic image forming in the electrophotographic part 200. That is, the paper only passes the ink jet unit section 308. As a result, the order of the papers discharged to the tray 229 agrees with the order of the documents set in the automatic document feeder 110.

If the quality mode is decided to be set at step S22, the flow proceeds to step S27 to perform the above-mentioned processing on the color document.

If the high speed mode is decided to be set at step S22, the flow proceeds to step S29 to perform the above-mentioned processing on the monochromatic document.

If it is decided that copies on all the documents set in the automatic document feeder 110 are completed (YES at step S33), the flag F is reset to zero (step S34). On the other hand, if it is decided that copies on all the documents are not completed (NO at step S33), the flow returns to step S17.

In the above-mentioned image forming, when no ink jet unit is installed, the image data received from the external apparatus are saved in the RAM 613. However, the data received from the external apparatus may be inhibited by omitting the RAM 613. In this case, the copying machine cannot be used as a printer for the external apparatus.

Next, the document discrimination (FIG. 13A, step S23) is explained. A monochromatic image has achromatic colors having almost zero of chromaticity components a* and b*. For example, when the average information LA on a* and b* in a 4*4 pixel block obtained by the generalized block truncation coding is within ±5, it can be decided that the block has an achromatic image. However, if only this criterion is used, an error may happen. For example, even if the chromaticity component a* of a pixel is −120 and that of another pixel is 125, the block may be decided erroneously an achromatic image when the average information LA is +5. Then, in order to avoid this error, it is decided that 4*4 pixel block belongs to a monochromatic image if a further condition is satisfied that the gradation width index LD is within +5.

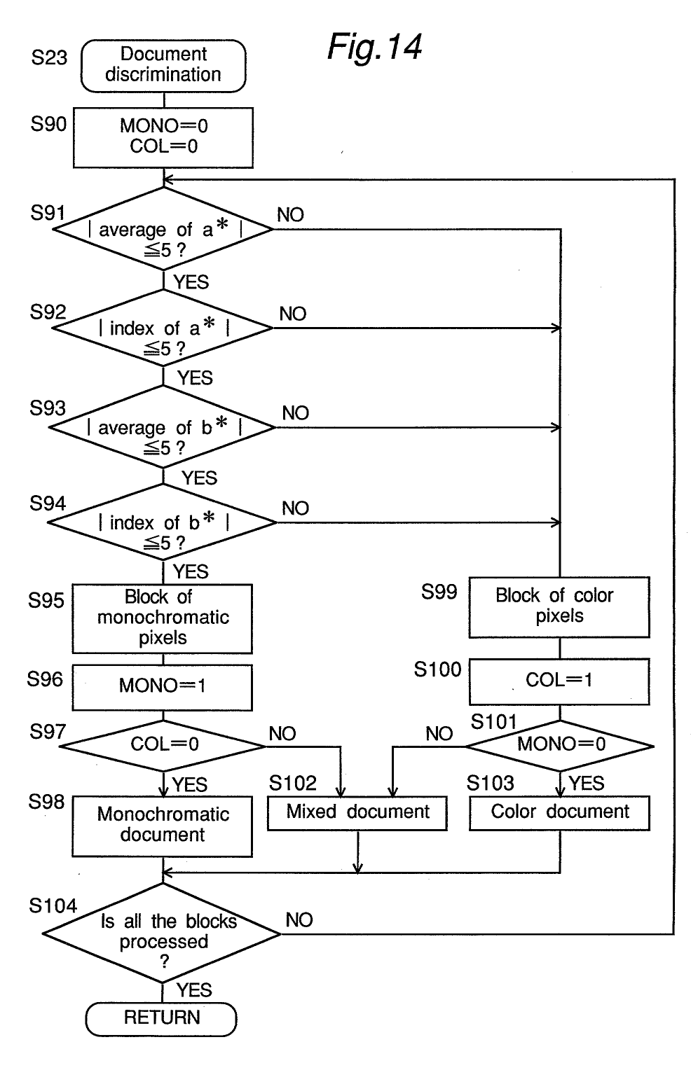

The document discrimination is explained further with reference to FIG. 14. First, flag MONO for monochromatic document and flag COL for color document are reset to zero (step S90). Then, if the average information LA and the gradation width index LD of a* and b* are within ±5 (YES at steps S91-S94), it is decided that the 4*4 pixel block is decided to be a block belonging to a monochromatic image (step S95), and flag MONO is set to one (step S96). Then, if flag COL is decided to be zero (YES at step S97), the block is decided to belong to a monochromatic document (step S98), but if flag COL is decided to be one (NO at step S97), the block is decided to belong to a mixed document (step S102).

On the other hand, if at least one of the conditions of steps S91 to S94 is not satisfied, it is decided that the 4*4 pixel block is decided to be a block belonging to a color image (step S99), and flag COL is set to one (step S100). Then, if flag MONO is decided to be zero (YES at step S101), the block is decided to belong to a color document (step S98), but if flag MONO is decided to be one (NO at step S110), the block is decided to belong to a mixed document (step S102). If the above-mentioned discrimination has not yet been performed on all the blocks (YES at step S104), the flow returns to step S91 to repeat the discrimination.

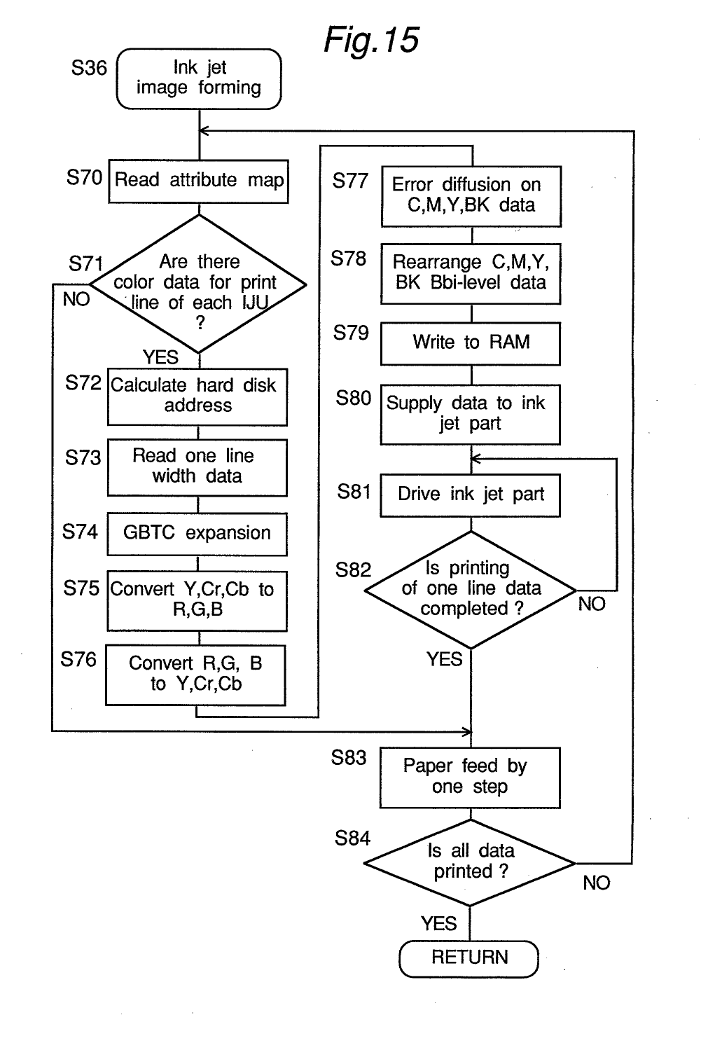

Next, image forming by the ink jet part 300 (FIG. 13B, step S36) is explained. FIG. 15 is a flowchart of the ink jet image forming. First, the attribute map on a document image to be printed is read from the hard disk 612 (step S70). The positions of the attribute maps of the document image to be printed are stored in the page address table 505, and the position of the attribute map of the relevant page is determined by referring to the page address table 505. When printing is performed on two faces of a sheet of paper or images of two pages are printed on the same face of a sheet of paper, attribute maps of a plurality of pages are read to obtain necessary document image information.

If color data is decided to exist in a print line for each ink jet unit by taking into account the number of the ink jet units and the positions of color data areas in the attribute map (YES at step S71), the address of the color data in the hard disk 612 and the data width thereof are calculated with reference to the attribute memory (step S72). Then, data of the data width are read from the calculated addresses from the hard disk 612 and stored in the work RAM 608 (step S73). Next, the data in the work RAM 608 are expanded according to generalized block truncation coding (step S74). Then, YCrCb data are converted to RGB data (step S75), and the RGB data are converted to gradation data of cyan, magenta, yellow and black (step S76). Next, the gradation data of cyan, magenta, yellow and black are converted to bi-level data according to, for example, error diffusion or dither processing (step S77), and the bi-level data are rearranged for the convenience to supply them to the ink jet units (step S78). That is, data of one bit for each color are taken out in the unit of eight pixels in the subscan direction (or in the direction of arrangement of the ink jet units) to be processed as byte data. Each ink jet unit has a head for sixteen pixels in the subscan direction, and it needs data of a number of pixels along a line times two bytes. Then, the rearranged data of cyan, magenta, yellow and black are written to the work RAM (step S79), and data request from the ink jet unit controller 610 is waited. The above-mentioned steps S74-S78 can also be performed with a hardware circuit as a part of the ink jet unit controller 610, and this increases processing speed and reduces the load of the CPU 607. The data for one line written to the work RAM 608 at step S79 is supplied to the ink jet heads through the DMA controller 609 and the ink jet unit controller 610 (refer to FIG. 5) (step S80). When the CPU 607 moves the ink jet heads along the paper supply direction according to the data supply (step S81), until one line data is printed completely (step S82). Then, one line is fed for the paper (step S83), and if printing of the whole data is decided not to be completed (NO at step S84), the flow returns to step S70 to continue printing.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image forming apparatus comprising:
a first image forming part for forming an image on a sheet of paper;
a first path for carrying a sheet of paper through said first image forming part;
a second image forming part for forming an image on a sheet of paper;
a second path for carrying a sheet of paper through said second image forming part;
a third path for carrying a sheet of paper to an external tray;
a switch device which connects said first path to said second path or to said third path; and
a controller for inhibiting said switch device to connect said first path to said third path when said switch device once connects said first path to said second path when images of a plurality of documents are formed successively.

2. The image forming apparatus according to claim 1, wherein said first image forming part uses an electrophotographic process and said second image forming part uses an ink jet print process.

3. The image forming apparatus according to claim 1, further comprising an image discrimination means for discriminating a color area included in a document, wherein an image of the color area is formed by said second image forming part when said image discrimination means discriminates the color area.

4. The image forming apparatus according to claim 3, wherein images other than the color area are formed by said first image forming part.

5. The image forming apparatus according to claim 4, wherein if said switch device once connects said first path to said second path and said image discrimination means decides that no color area is included in a next document, said second image forming part only passes a sheet of paper carried through said second path, without forming an image on the sheet of paper.

6. An image forming apparatus comprising:
a first image forming part for forming an image on a sheet of paper;
a paper cassette which contains a plurality of sheets of paper;
a first paper supply device to supply a sheet of paper from said paper cassette to said first image forming part;
an intermediate tray for stacking a paper discharged from said first image forming part;
a second image forming part for forming an image on a paper; and
a second paper supply device to supply a sheet of paper stored in the intermediate tray to said second image forming part.

7. The image forming apparatus according to claim 6, wherein said first image forming part uses an electrophotographic process and said second image forming part uses an ink jet print process.

8. The image forming apparatus according to claim 7, further comprising a sensor for detecting whether a number of sheets of the paper stacked in said intermediate tray reaches a predetermined number and a controller which stops said first paper supply device to supply a sheet of paper to said second image forming part when said sensor detects that the number of sheets of the paper stacked in said intermediate tray reaches the predetermined number.
